SEQUENCE LISTING (4 sequences)

SEQ ID NO: 1 - DNA, 20 bp, Artificial Sequence
  forward primer
agacgtgtgctcttccgatc

SEQ ID NO: 2 - DNA, 20 bp, Artificial Sequence
  Reverse Primer
acacgacgctcttccgatct

SEQ ID NO: 3 - DNA, 148 bp, Artificial Sequence
  Synthetic Polynucleotide
  misc_feature: Sequence (5′-3′)
acacgacgctcttccgatctgactctcatctactagatagatctccacctcgcagtctcgtcttcaacggtgctcacgcgatatagttagctcgcgactaccatagcgctacatagaagtcagcaagagatcggaagagcacacgtct

SEQ ID NO: 4 - DNA, 148 bp, Artificial Sequence
  Synthetic Polynucleotide
  misc_feature: Sequence (5′-3′)
agacgtgtgctcttccgatctcttgctgacttctatgtagcgctatggtagtcgcgagctaactatatcgcgtgagcaccgttgaagacgagactgcgaggtggagatctatctagtagatgagagtcagatcggaagagcgtcgtgt

(19) United States
(12) Patent Application Publication
(10) Pub. No.: US 2021/0046475 A1
(43) Pub. Date: Feb. 18, 2021

(54) SAMPLE HOLDER, METHOD FOR MANUFACTURING THE SAMPLE HOLDER, AND APPARATUS FOR RECEIVING THE METALLIC SAMPLE HOLDER

(71) Applicant: ETH Zürich, Zürich (CH)

(72) Inventors: Wendelin Jan Stark, Langenthal (CH); Robert N. Grass, Zurich (CH); Michele Gregorini, Zurich (CH)

(21) Appl. No.: 16/955,943

(22) PCT Filed: Dec. 20, 2018
(86) PCT No.: PCT/EP2018/086348

§ 371 Date: Jun. 19, 2020

(30) Foreign Application Priority Data
Dec. 22, 2017 (EP) 17210445.7

(51) Int. Cl. B01L 3/00; B01L 7/00

(52) U.S. Cl. CPC B01L 3/50851; B01L 7/52; B01L 3/50853; B01L 2300/1822; B01L 2300/0819; B01L 2300/0851; B01L 2300/0893; B01L 2200/025

(57) ABSTRACT

The present invention relates in a first aspect to a metallic sample holder (1), in particular for capturing sample volumes for digital polymerase chain detection. The sample holder (1) comprises an array of indentations (10), wherein each indentation (11) is adapted to capture a maximal sample volume vₘₐₓ, with vₘₐₓ=2 nl, in particular with vₘₐₓ=1 nl, in particular with vₘₐₓ=0.8 nl. Each indentation (11) of the array (10) has an area cross-section section a, with a ≤8*10⁻³ mm², in particular with a ≤5*10⁻³ mm². A second aspect of the invention relates to a method for manufacturing the sample holder (1). A third aspect of the invention relates to an apparatus (200), in particular for polymerase chain reaction detection, adapted for receiving the metallic sample holder (1). A fourth aspect of the invention relates to the use of the sample holder (1) by means of the apparatus (200).

### CROSS-REFERENCE TO RELATED APPLICATION

This is the United States national phase of International Patent Application PCT/EP2018/086348, filed Dec. 20, 2018, which claims priority to EP17210445.7 filed Dec. 22, 2017, the entire contents of each of which are hereby incorporated by reference.

### INCORPORATION BY REFERENCE OF MATERIAL SUBMITTED ELECTRONICALLY

The Sequence Listing, which is a part of the present disclosure, is submitted concurrently with the specification as a text file. The name of the text file containing the Sequence Listing is “55566_Seqlisting.txt”, which was created on Aug. 10, 2020 and is 1,461 bytes in size. The subject matter of the Sequence Listing is incorporated herein in its entirety by reference.

### TECHNICAL FIELD

The present invention relates to a sample holder, a method for manufacturing thereof, an apparatus for receiving the sample holder, and a use of the sample holder by means of the apparatus.

### BACKGROUND ART

Polymerase chain reaction (PCR) is a technique used in molecular biology for repeatedly replicating focused segments of deoxyribonucleic acid molecules (DNS). In particular, such a reaction process relies on thermal cycling of the samples, involving exposure of the samples to cycles of repeated heating and cooling. Thermal cycling can be utilized to provide heating and cooling of multiple reaction vessels, which may contain biological and/or chemical substances in order to carry out specific reactions.

Such PCR techniques are well known in the field. For example, such techniques are disclosed in U.S. Pat. No. 4,683,202.

In particular interesting is the technique of digital polymer chain reaction (dPCR) detection. The technique allows immediate analysis and quantification of the result. The technique is further explained in Vogelstein, B. et al. “Digital PCR”, Proc. Natl. Acad. Sci. USA, vol. 96, pp 9236-9241, 1999. Incorporated by reference is in particular the “Results” section of said reference on pages 9237 to 9239.

There are many different types of apparatuses for performing detection of dPCR.

One of the essential components of such an apparatus is the sample holder. Conventionally, thermal cycling devices include a thermal block that is designed to capture tubes or plates that carry the sample volumes.

One or more Peltier units are used to heat or cool the thermal block that has a thermal mass at least one hundred times larger than the thermal mass of sample volumes captured within the tubes or plates.

Moreover, the cooling or heating capacity of the Peltier elements depends mainly on the cooling respectively heating rate of the thermal block. The time that it takes for cooling or heating the large thermal block is therefore significant for the duration of the whole measurement.

In addition, it is desirable to control the temperature change of the sample volumes in a manner that accurately attains the target temperature, avoids undershooting or overshooting of the temperature, and quickly reaches the target temperature. Such control of temperature may inhibit side reactions, the formation of unwanted bubbles, the degradation of components at certain temperatures, etc., which may occur at non-optimal temperatures. The temperature of the sample volumes that are captured in the tubes or plates can nearly not be monitored for this type of sample holder, since it might deviate from the temperature of the thermal block.

Furthermore, thermal cycling devices are used in many diagnosis procedures, both in centralized laboratories and in point-of-care (POC) diagnosis. In the latter case portability is a key POC feature. Conventional dPCR detection apparatuses are very heavily built. The heavy weight results in particular from the mechanical and electronical components that are used for aligning the sample holder and the optical detector relatively to each other for PCR detection. Such components are not only heavy but are additionally also very energy consuming.

Document US 2015/045252 A1 shows a system for determining the number of target nucleotide molecules in a sample that includes a sample holder, an excitation optical system, an optical sensor, and an emission optical system. The sample holder is configured to receive an article comprising at least 20,000 separate reaction sites. The excitation optical system comprises a light source configured to simultaneously illuminate the at least 20,000 separate reaction sites. The optical sensor comprises a predetermined number of pixels, the predetermined number of pixels being at least 20 times the number of separate reaction sites. The emission optical system comprises a system working distance from the sample holder, wherein the working distance is less than or equal to 60 millimetres.

Document US 2016/271604 A1 shows a sample loader for loading a liquid sample into a plurality of reaction sites within a substrate. The sample loader includes a first blade, and a second blade coupled to the first blade. The sample loader further comprises a flow path between the first blade and second blade configured to dispense a liquid sample to a substrate including a plurality of reaction sites. Further, in various embodiments the liquid sample has an advancing contact angle of 85+/−15 degrees with the first and second blade. Furthermore, loading of the liquid sample dispensed from the flow path to the plurality of reaction sites may be based on capillary action. The first and second blade may dispense the liquid by laterally moving over the plurality of reaction sites, where a motor laterally moves the first and second blade.

Document US 2002/0136969 A1 is a laser-engravable recording material for producing relief printing plates, in particular for producing flexographic printing plates, comprising a dimensionally stable support and a recording layer comprising silicone rubbers and inorganic ferrous solids and/or carbon black as absorbers for laser radiation; of processes for producing relief printing plates by laser engraving such recording materials; and of relief printing plates having a printing relief comprising silicone rubbers and inorganic ferrous solids and/or carbon black.

WO 2017/127570 A1 shows devices for amplifying and detecting analytes, including oligonucleotide targets. The devices may be used for point of care nucleic acid testing. Methods and assays of using the devices are also disclosed.

### DISCLOSURE OF THE INVENTION

The problem to be solved by the present invention is therefore to provide a metallic sample holder and an apparatus for receiving the sample holder, which overcome the disadvantages of the prior art.

The problem is solved by the subjects of the independent claims. Accordingly, a first aspect of the invention concerns a metallic sample holder that is in particular configured to capture sample volumes for digital polymerase chain reaction (PCR) detection. The sample holder comprises an array of indentations.

The indentations are preferably arranged in a regular pattern to enable facile preparation of the samples, in particular by means of automated preparation. In particular, the sample volumes are directly filled into the indentations. Therefore, the preferably liquid sample volumes are directly in touch with the sample holder surface within the indentations.

In a further preferred embodiment, the indentations are arranged in a very specific pattern, to provide a unique array, e.g. for applying specific identification mechanisms on the particular array. Such identification methods might be correlated with a specific arrangement of the indentations.

The indentations correspond preferably to so called sample wells, wherein each indentation corresponds to one sample well for PCR detection. The term indentations refers therefore in particular to cavities in the sample holder. Preferably, these indentations are formed by removing material from a plate representing the sample holder yet without indentations. In particular, the term indentations can further refer to recesses in the sample holder.

Each indentation is adapted to capture a maximal preferably liquid sample volume vₘₐₓ, with vₘₐₓ=2 nl, preferably with vₘₐₓ=1.5 nl, very preferably with vₘₐₓ=1 nl or 0.8 nl. The liquid sample is directly filled into the indentations.

In particular, adapted to capture a maximal volume can mean that the indentations are configured or suitable to receive the respective volume. E.g. that the indentations have the respective form to capture the respective volume.

For filling the indentations with the sample volume, a liquid sample is preferably spread over the array of indentations and fills up every well by means of adhesion forces between the sample holder's material and the water matrix of the liquid sample. The low contact angle between the liquid and the solid bodies guarantee that each well is entirely filled.

In particular if the sample holder is made of aluminum, the contact angel between the sample holder and the liquid sample is low due to the high surface energy γ of the aluminum with γ>150 mJ/m². The good wetting properties of aluminum make it favourable over other materials for the application of the sample holder.

Good wetting properties and therefore in particular high surface energies promote filling of the indentations.

In particular, a coating of the sample holder would also decrease the surface energy and would therefore be disadvantageously.

In particular, the small diameters of the indentations cause strong capillary forces such that each indentation is filled with the sample volume.

The sample volumes preferably comprise fluorescence-conjugated DNA probes.

It is in particular not necessary to coat a preferred aluminum sample holder because the adsorption of DNA on the aluminum surface is prevented by the presence of proteins, e.g. bovine serum albumin (BSA) in the sample volumes. Such proteins are standard in PCR reagents.

Each indentation of the array has an area cross-section a, with a ≤8*10-3 mm², in particular with a ≤5*10-3 mm².

In regard of the captured volume and the cross-section of the indentation, the depth of the indentation is preferably in the range of 10 μm to 200 μm, preferably in the range of 10 μm to 100 μm, preferably in the range of 10 μm to 60 μm, preferably in the range of 100 μm to 200 μm.

In a further embodiment, the captured sample volume might be less than the maximal sample volume that the indentation can capture, such that the surface of the liquid sample forms a concave film in the indentation. The shape of the surface of the liquid sample volume might further range from a convex disc through a flat disc to a concave disc.

In a preferred embodiment, the indentations are cylindrically shaped. In further embodiments, the indentations can further have a hemispherical shape, a conical shape, or an elliptical cone shape. The shape of the indentations refers to the shape that the indentations form in the material.

In particular, at least a large part of the bottom area of the indentation is flattened, but it can further have a convex or concave area.

The indentations have a bottom area. The bottom area as well as the walls of the indentation are in particular configured to reflect an optical signal. The specific bottom area of the indentations is preferably adapted, this can mean configured or suitable for, to optimally reflect an optical signal. Adapted to optimally reflect an optical signal in particular refers to a bottom area reflecting an optical signal, totally reflecting an optical signal, or reflecting an optical signal to more than 50%.

In a preferred embodiment of the invention, the bottom area is flat and is essentially formed rectangular to the walls of the indentations.

In a further preferred embodiment of the invention, the bottom area is flat wherein the transition of the walls of the indentation to the flat bottom are is rounded, such that the bottom area forms a flattened half sphere.

Preferably, the indentation is manufactured with the manufacturing method of according to the second aspect of the invention that leads to very flat surfaces, in particular very smooth surfaces. Such characteristics are preferably for the sample holder since it reflects much more of the optical signal by this configuration.

In a preferred embodiment, the indentations are essentially cylindrically.

The array of indentations of the metallic holder comprises preferably at least 10,000 indentations, very preferably at least 40,000 indentations.

The spacing between the indentations of the array can be varied and is in particular a result of the density and size of the particular array. Anyway, the spacing between the individual indentations should be large enough to prevent interferences between the individual sample volumes captured in the indentations.

The sample holder is preferably made out of a rigid material, preferably, wherein the material possesses both, high stiffness and high thermal conductivity.

The preferred manufacturing of the sample holder out of a stiff material prevents deformation of it and of the walls of the indentations. Metals are preferred materials due to their intrinsic stiffness and generally high thermal conductivity. In addition, metals are very temperature stable such that they can be exposed to high temperatures, e.g. for cleaning and sterilization procedures.

In particular, the sample holder does not require any coating. The surface of the indentations of a preferred sample holder is therefore free of any coating. The material of the sample holder, in particular the aluminum surface, would therefore be in direct contact with the sample volumes in each indentation.

The sample volume can be filled directly into the indentations of the metal sample holder, in particular by means of capillary forces.

The advantage of a metallic sample holder lies further in its reflective properties that simplifies the detection of any light signal generated within the sample volume during the chemical or biochemical reaction.

Preferably, the sample holder is made of aluminum, silver, gold, copper, or alloys thereof. In a further preferred embodiment, the sample holder might be made out of steel.

The material for the sample holder is preferably chosen to have a high thermal conductivity for good thermal transport and/or high stiffness for a high stability of the shape of the sample holder.

A preferred embodiment of the sample holder can further comprise a non-metallic covering sheet for covering the array of indentations. The covering sheet in particular avoids evaporation of the sample volumes captured in the indentations. The covering sheet might be fabricated out of any material that does not interfere with the sample volume. The sheet might have a hydrophobic character or comprise a hydrophobic layer. It might be deformable, e.g. like silicon rubber, or might be rigid, e.g. like polymeric glass. The sheet is preferably releasable from the sample holder.

In a further preferred embodiment, the indentations are covered by means of a hydrophobic medium for preventing evaporation of the sample volumes. Such medium might be an inert liquid that is non-miscible with water and does not react with the sample holder material or the sample volumes. An example for such a medium might be oil, in particular mineral oil or silicone oil. Such medium is in particular applied directly after filling the indentation with the sample volume. Such sample preparation might be processed by means of two automated pipettes, wherein one is filled with the liquid sample volume and one is filled with the liquid medium for covering the sample volume. The pipettes could be applied after each other to each indentation for filling in the sample volume and covering it with the medium directly afterwards.

In a further embodiment of the invention, evaporation of the sample volumes might be prevented by placing the sample holder into a humidity chamber.

According to a second aspect of the invention, the array of indentations in the sample holder is manufactured by means of laser engraving. Preferably, the sample holder is formed as a single piece.

Also other techniques for the fabrication of the sample holder known in the field might be used for manufacturing the sample holder, such as micromachining or microfabrication techniques.

In particular, the method of laser engraving allows an easy fabrication of individualized arrays of indentations on the sample holder. By the method of laser engraving, one layer after the other is removed by vaporization of the material. By laser engraving, the shape of the indentations, their arrangement and their number can be easily varied. Such individualization allows e.g. the identification of a certain array or might even simplify the readout of the sample volumes in the indentations by means of automated analysis thereof.

Preferably, a particular laser engraving procedure is applied, where the indentations are progressively engraved in distinct steps rather than with a continuous engraving process.

For example the laser engraving is performed by pulsing the laser repeatedly, in particular at least 10 times, very particular at least 20 times, during with pauses of at least 1 second, in particular with pauses of at least 2 seconds, very particular with pauses of at least 3 seconds.

In a preferred method for fabricating the sample holder, the array of indentations in the sample holder is manufactured by means of laser engraving and one or multiple steps of wet chemical wet etching.

Chemical wet etching involves in particular immersion of a substrate in a pure mixture of chemicals for a given amount of time. When the substrate is in contact with the one or more chemicals in the solution, one or more chemical reactions consume the original material to produce new products. The time required for the reaction depends on several factors, amongst which are the choice of the chemicals, the concentrations, the substrate, the temperature and the desired effect produced on the substrate.

By chemical wet etching, in particular the internal roughness of the indentations was found to be reduced and this improved the reflective properties and reduced the surface-to—volume ratio of the indentations.

An example of an etching procedure that can be used to achieve this purpose includes, but is not limited to, immersion of the substrate into a 1 mol/L aqueous solution of sodium hydroxide (NaOH) at 80° C. for 30 seconds.

A third aspect of the invention refers to an apparatus, in particular for polymerase chain reaction, adapted or suitable for receiving the metallic sample holder. The sample holder is in particular used in conjunction with the apparatus. The apparatus comprises a thermal setting element. The thermal setting element is adapted to be connectable to the sample holder for controlling the temperature of the sample holder, if the sample holder is mounted to the apparatus. If the thermal setting element is coupled to the sample holder, it heats or cools down the sample holder. It can therefore be defined as a “heating and/or cooling element”. The thermal setting element can work in the range of 10-120° C., preferably it works in the range of 40-100° C.

The thermal setting element can comprise a stage for mounting the sample holder. In particular such a stage could comprise an attachment element, e.g. a clip, to fix the sample holder to the stage, such that good thermal transport is achieved between the sample holder and the thermal setting element, respectively its stage.

Preferably, the thermal setting element is a Peltier thermoelectric device. Such a Peltier device can be constructed of pellets of n-type and p-type semiconductor material that are alternately placed in parallel to each other and are electrically connected in series. Examples of semiconductor materials that can be utilized to form the pellets in a Peltier device, include but are not limited to, bismuth telluride, lead telluride, bismuth selenium and silicon germanium. However, it should be appreciated that the pellets can be formed from any semiconductor material as long as the resulting Peltier device exhibits thermoelectric heating and cooling properties when a current is run through the Peltier device. In various embodiments, the interconnections between the pellets can be made with copper which can be bonded to a substrate. Examples of substrate materials that can be used include but are not limited to copper, aluminum, aluminum nitride, beryllium oxide, polyimide or aluminum oxide. In various embodiments the substrate material can include aluminum oxide also known as alumina. It should be understood, however, that the substrate can include any material that exhibits thermally conductive properties.

Peltier devices are solid state devices that operate as heat pumps and thus may be used to absorb heat from the substrate, thereby cooling the substrate or, in the alternative, may be used to generate heat and thereby warm the substrate.

Preferably, the thermal setting element is configured to provide both active heating and active cooling of the sample holder. The two functions are therefore both integrated into the one thermal setting element. Therefore, active heating and cooling of the sample holder is provided.

In particular, the sample holder is thermally very well coupled to the thermal setting element, such that the thermal conductivity between the holder and the element is very high. To achieve the high thermal conductivity between the two, the sample holder, when mounted to the apparatus, is pressed against the thermal setting element, in particular by means of a clamp mechanism.

Fast heat transfer between the thermal settling element and the sample holder is in particular enabled by means of a high thermal interface conductance of the two. To achieve a high conductance, a low-thermal mass sample holder must be in close contact with the thermal settling element. Such configuration is provided by the present invention.

In a preferred embodiment of the invention, the thermal interference conductance between the thermal setting element and the sample holder is therefore at least 1000 W/(m²K), preferably at least 4000 W/(m²K), very preferably at least 8000 W/(m²K).

A preferred embodiment of the apparatus comprises a body. The body of the apparatus is in particular defined as being a shell or a housing that surrounds all the components of the apparatus. The body can therefore be a metallic shell or a metallic scaffold that holds the components together.

Preferably, the body consists of at least 80 wt % metal, preferably of at least 90 wt % metal. The metal is preferably aluminum.

In a preferred embodiment, the sample holder is thermally coupled to the body of the apparatus, wherein this body itself serves as a passive heat sink for the sample holder. By efficiently conducting the heat from the sample holder to the body, the sample holder can be cooled down very quickly.

Thermal contact between the components, in particular between the sample holder and the body, is preferably provided by the use of a thermally conductive paste.

The apparatus comprises further a controller, for controlling a thermal cycle of the thermal setting element. Many chemical and biochemical reaction experiments require to change the temperature of the sample volume in a predefined procedure, so called thermal cycling. Such thermal cycling is in particular important for polymerase chain reaction detection. Such thermal cycling can be repeated up to thirty or fifty times during one PCR measurement series.

In respect of the apparatus, the controller is adapted to control the thermal setting element, such that the thermal setting element heats up or cools down the sample holder to a temperature commanded by the controller.

Preferably, the thermal setting element heats the sample holder with a net effective heating ramp equal or higher than 5.0° C./s (net effective heating ramp 5.0° C./s), preferably with a net effective heating ramp equal or higher than 8.0° C./s (net effective heating ramp 8.0° C./s), or very preferably with a net effective heating ramp equal or higher than 10.0° C./s (net effective heating ramp 10.0° C./s). Wherein a higher heating ramp corresponds to faster heating.

Preferably, the thermal setting element cools down the sample holder with a net effective cooling ramp equal or lower than −5.0° C./s (net effective cooling ramp≤−5.0° C./s), preferably with a net effective cooling ramp equal or lower than −8.0° C./s (net effective cooling ramp≤−8.0° C./s), or very preferably with a net effective cooling ramp equal or lower than −10.0° C./s (net effective cooling ramp≤−10.0° C./s). Wherein a lower cooling ramp corresponds to faster cooling.

The heating or cooling procedure of the thermal element is preferably controlled by the controller. In particular, the controller can therefore request the temperature sensor, if there is any, to provide respective temperature data of the sample holder for monitoring the heating or cooling procedure.

The maximal speed of the thermal cycle and therefore the maximal speed of one measurement series of the sample volumes is accordingly dependent on how quick the sample holder changes its temperature. As mentioned above, in regard of the inventive apparatus, this change of temperature is accelerated by thermally coupling the sample holder to the body of the apparatus that serves as a heat sink.

Quickly switching between the target temperatures and therefore quickly going through the thermal cycle, raises several advantages. First, the chemical reaction has an optimum temperature for each of its stages and as such less time spent at non-optimum temperatures. Secondly, a minimum time is usually required at any given set point which sets minimum cycle time for each protocol and any time spent in transition between set points adds to this minimum time. Since the number of cycles is usually quite large, this transition time can significantly add to the total time needed to complete the amplification.

In a preferred embodiment, the controller is arranged within the apparatus. In another embodiment, the controller can also be arranged externally of the apparatus.

The apparatus comprises further an optical detector that is arranged in line of sight of the array of indentations of the sample holder, if the sample holder is present.

The arrangement in line of sight of the array of indentations of the sample holder means that the optical detector can receive optical signals from the indentations, if the sample holder is mounted to the apparatus. In particular, the optical detector can receive signals from the flattened bottom area of each of the indentations.

Preferably, the excitation source and the detector are optimized to take advantage of the internal reflective surfaces of the wells, in particular of a flat bottom area of the indentations.

In a preferred embodiment, the detector is arranged directly above the sample holder, wherein the detection area of the detector and the surface of the sample holder are aligned in parallel. Preferably, the optical detector is a colour charge-coupled device (CCD) or a complementary metal-oxide-semiconductor (CMOS) type camera which is focused on the sample holder for simultaneous detection of several targets.

The optical detector is configured to detect at least one optical signal, in particular a fluorescent or a chemiluminescent signal, from one sample volume of one indentation of the sample holder.

In a typical fluorescent assay system, a fluorescent probe or fluorophore assay system, a fluorescent probe or fluorophore absorbs light having a wavelength or range of wavelengths. If such fluorophore is excited, it emits a fluorescent signal. The activity or inactivity of the fluorophore is indicative of the assay properties. The emitted signal has a wavelength or range of wavelengths that is longer than the wavelength of the excitation wavelength. A dichroic beam splitter or band-pass filter, or a combination thereof, can be used to separate the fluorescent signal from other signals.

The optical detector of a preferred embodiment of the apparatus has no movable components. Therefore, no heavy construction for moving the detector within the apparatus is required. The optical detector is preferably fixed at its position. In a further embodiment, the optical detector might comprise gratings for selecting specific wavelengths, filters for allowing only certain wavelengths to pass, and multiple lenses or filters optimized for multiple excitation sources or detectors might be used.

In a preferred embodiment, the apparatus runs without a light source and optical detection of the optical signal of the sample volumes can be done by exciting the sample volume by means of the environmental illumination only.

In a further embodiment, the apparatus comprises an excitation light source, in particular a LED, a high power LED or a mercury light source. The light source enhances the excitation of the sample volumes and therefore amplifies the optical signal emitted by the sample volumes.

The light source can be directly mounted to the body of the apparatus and might be thermally connected to the body of the apparatus such that the heat of the light source dissipates to the body.

In a further embodiment, an emission filter or a detection filter can be arranged between the light source and the sample holder, for improving the optical sensitivity of the optical detector.

The light source might illuminate the sample volumes continuously during the temperature cycling or discontinuously, meaning that it turns off between the individual measurements for saving energy. In particular, the controller can steer the light source to turn on and off in accordance with the status of the measurements.

In a preferred embodiment of the apparatus, the controller is configured to control the optical detector. Therefore, the controller can be connected to the detector and can be adapted to send commands to the detector. Such commands might concern the pace of recording optical data, in particular in respect of the thermal cycling of the temperature of the sample holder.

Preferably, the optical detector records at least one optical signal for each thermal cycle of the thermal setting element.

Preferably, the controller is further configured to control the optical detector for recording a plurality of optical signals from a plurality of sample volumes of a plurality of indentations for each thermal cycle.

In particular, the optical detector of the apparatus is configured to assign each optical signal to the corresponding sample volume. Therefore, for such an embodiment, each signal of each indentation can be recorded and identified immediately. As a result, such an apparatus provides immediate detection and identification of all sample volumes captured in the indentations.

A further embodiment of the apparatus comprises at least one temperature sensor for sensing the temperature of the sample holder. Such temperature sensor might be a thermistor, a thermocouple, a negative temperature coefficient (NTC) thermistor, a resistance temperature detector (RTD), a platinum resistance devices (PRT), a bimetallic device, a liquid expansion device, a molecular change-of-state device, a silicon diode, an infrared radiator, a silicon band gap temperature sensor or any other semiconductor based sensor.

In particular, the temperature sensor is connected to the controller and the thermal setting element for providing a feedback loop for controlling the temperature of the sample holder. In such an embodiment, the controller e.g. predefines a specific temperature value and sends respective commands to the thermal setting element for heating or cooling the sample holder, wherein the temperature sensor informs the controller as soon as the sample holder reaches the respective temperature.

Preferably, the controller can additionally be connected to the optical detector. For such an apparatus, the controller controls the thermal cycle in respect of the temperature sensor, the thermal setting element and the optical detection. In particular, the controller can send a command to the thermal setting element for requesting heating or cooling of the sample holder, wherein the temperature of the sample holder is monitored by the thermal sensor. The controller can prompt the optical detector to start recording the optical signals from the sample volumes captured in the sample holder. This procedure might be repeated for every temperature of the thermal cycle.

In particular, the controller is additionally connected to the light source. For such an apparatus, the controller is steering the light source. The controller can turn the light source on and off depending on the thermal cycle of the thermal setting element. In particular, the control of the light source is further correlated with the optical detector. E.g. the light is turned on before recording an optical detection signal from the sample volume with the optical detector and is turned off after the optical detection is finished.

To prevent evaporation of the sample volumes from the sample holder, the apparatus with the sample holder could be placed into a humidity chamber. In such a chamber, the atmosphere of an open apparatus at saturated vapor pressure and periodic addition of water to the chamber, e.g. by means of a piezoeletric or other dispenser, prevents the evaporation of the sample volumes.

The apparatus is in particular designed to make it portable. In this respect it is advantageously that the apparatus can run without an extra light source and without a temperature sensor.

Additionally, as mentioned above, the optical detector can be fixed to its position in line of sight to the sample volumes for detection of the optical signals of the samples. Therefore, no complicated position controlling mechanism for the optical detector is required and thus the apparatus can be constructed very light weight.

Because the apparatus can be reduced to comprising only the thermal setting element, the controller, and the optical detector, it runs at very low power. Therefore, a battery as a power source might be sufficient to run the apparatus.

In particular, the apparatus is less than 1 kg in weight.

A fourth aspect of the invention refers to the use of the sample holder for polymerase chain reaction detection of sample volumes in particular by means of the apparatus.

For performing measurements of particular liquid samples, sample volumes are filled into the indentations of the sample holder as described above.

Afterwards, in a preferred embodiment of the invention, the sample holder is preferably fixed to a stage of the apparatus. In particular, the sample holder is thereby thermally connected to the sample stage by means of mechanical connectors or glue, e.g. silver paste. The stage is thermally connected to the body of the apparatus.

If the sample holder is mounted to the stage, it is preferably further connected to the thermal setting element.

A preferable usage of the sample holder refers to the use for performing fast, real-time, digital polymerase chain reaction.

The sample holder can be discarded after one use or can be reused after being sterilized. For sterilization, the sample holder is heated up to around 120° C.

Due to the simple design of the sample holder, the sterilization, e.g. by means of gamma radiation, is highly effective and therefore might be very powerful against contamination by polynucleotides.

A fifth aspect of the invention refers to an indentation manufactured by a method comprising the steps of laser engraving, wherein the laser engraving is performed by pulsing the laser repeatedly with pauses of at least 1 second, preferably with pauses of at least 2 seconds, more preferably with pauses of at least 3 seconds.

In particular, the indentation is manufactured in the metallic sample holder according to the first invention.

In particular, the laser is pulsed with at least 20 kHz, wherein the pulse duration is at least 50 μs, preferably at least 100 μs.

A sixth aspect of the invention refers to a metallic sample holder comprising at least one of the indentations of the fifth aspect.

It is understood that the various embodiments, preferences, and method steps as disclosed in the specification may be combined at will, if not otherwise specified or explicitly excluded. Other advantageous embodiments are listed in the dependent claims as well as in the description below.

### BRIEF DESCRIPTION OF THE DRAWINGS AND EXPERIMENTS

The invention will be better understood and objects other than those set forth above will become apparent from the following detailed description thereof. Such description makes reference to the annexed drawings, wherein:

FIG. 1 shows a schematic of a metallic sample holder according to an embodiment of the invention,

FIG. 2a shows an enlarged section of the sample holder,

FIG. 2b shows a cross section of an indentation according to an embodiment of the invention,

FIG. 3 shows a schematic of a cross section of an apparatus according to an embodiment of the invention,

FIG. 4 shows a schematic perspective view of an apparatus according to an embodiment of the invention,

FIG. 5 shows a schematic view of a cross section of an apparatus according to an embodiment of the invention, and

FIGS. 6a and 6b show measurement results of experiments according to a preferred embodiment of the invention.

FIGS. 7a and 7b show measurement results of experiments according to a preferred embodiment of the invention.

### MODES FOR CARRYING OUT THE INVENTION

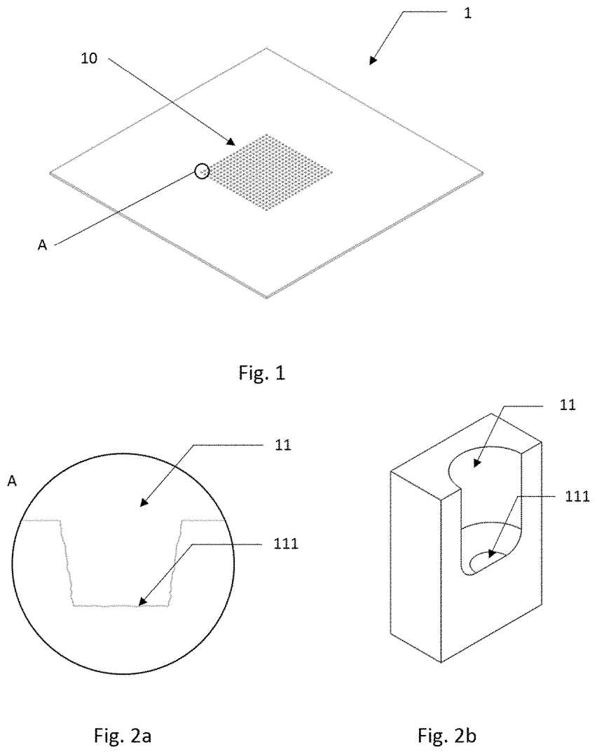

FIG. 1 shows a schematic view of a preferred embodiment of the metallic sample holder 1 according to the invention. The sample holder 1 comprises an array of indentations 10. The array 10 can cover selected areas of the sample holder 1 as shown in the figure or can extend over the full area of the sample holder 1. In particular, the indentations 11 of the array 10 can be arranged in a specific pattern. In the embodiment shown in the figure, the indentations 11 are arranged evenly spaced in a regular quadratic pattern.

A preferred embodiment of the invention comprises an array 10 with at least 10,000 indentations 11. The array of indentations 10 displayed in the figure showing only few indentations 11 is a symbolic illustration of the preferred array 10.

The metallic sample holder 1 is preferably made of aluminum.

A preferred size of the sample may be 4 cm times 4 cm. The small size and the correlating small mass of the sample holder allows fast heating and cooling of the holder and therefore faster thermal cycling. In particular, the arrangement of the array 10 on the sample holder 1 leaves space at the edge of the sample holder 1 to handle the holder 1 by means of hands or tweezers without interfering with the array of indentations 10. Preferably, no indentations 11 are arranged within a distance of 0.5 cm from the edge of the sample holder 1.

As shown in the enlarged section in FIG. 2a, the indentations 11 themselves are essentially of cylindrical shape. The essentially cylindrical shape can also tend to be slightly conical, for fabrication reasons, as shown in the figure.

In particular, the indentations 11 have an at least partially flat bottom area 111. The essentially flat bottom area 111 serves for reflecting an optical signal. In particular because the sample holder 1 is made of metal, the reflected optical signal is very strong and can be detected by an optical detector 4.

The sample volumes are directly filled into the indentations. No coating of the metallic sample holder 1 is required.

FIG. 2b shows a schematic cross section of one of the preferred indentations 11. In particular, the indentation 11 has a flat bottom surface 111 that promotes reflection of the optical signal within the indentation 11.

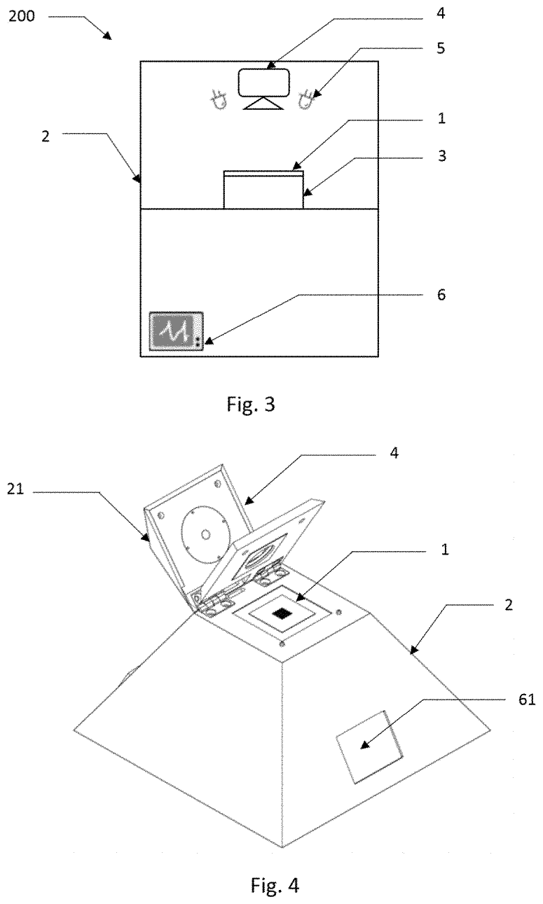

FIG. 3 shows a cross-section of a preferred embodiment of the apparatus 200. The apparatus 200 comprises a body 2. In the preferred embodiment shown in the figure, all components of the apparatus 200 are arranged within this body 2.

The apparatus 200 is adapted for receiving the metallic sample holder 1. In the figure, the apparatus 200 is illustrated comprising the sample holder 1. The apparatus 200 comprises a thermal setting element 3 that is thermally coupled to the sample holder 1 for controlling the sample holder 1 temperature. In the figure, the sample holder 1 is arranged on the thermal setting element 3.

In addition, the apparatus 200 further comprises a controller 6 for controlling the thermal cycle of the thermal setting element 3. The controller 6 might be arranged in a base body of the apparatus 200 as shown in FIG. 3. The controller 6 might comprise a screen 61 for displaying the cycling data. In particular, the controller 6 sends signals to the thermal setting element 3 for steering the heating or cooling of the thermal setting element 3. Since the thermal setting element 3 is thermally coupled to the sample holder 1, the sample holder 1 reaches the same temperature as the thermal setting element 3.

Therefore, the temperature of the sample holder 1 can be controlled by the controller 3. In addition, the temperature cycles of the sample holder 1 can also be controlled by the controller 3.

For example, three consecutive heating and cooling cycles are performed. Initially, the sample holder 1 is heated for 9 seconds, then it is kept at a temperature above 80° C. for 14 seconds and then it is cooled for 6.5 seconds. Preferably, the system is switched off for 10 seconds after every heating and cooling cycle.

The apparatus comprises further an optical detector 4 arranged in a way that the array of indentations 10 of the sample holder 1, if there is any sample holder 1 mounted to the apparatus 200, would be in line of sight of the optical detector 4. In line of sight of the optical detector 4 refers to the arrangement of the optical detector 4 in an optical line with the array of indentations 10, as shown in FIG. 3, where the optical detector 4 is arranged in an upper part of the body 2 of the apparatus 200. The thermal setting element 3 that preferably comprises a stage for the sample holder 1 is arranged in a centre part of the body 2 of the apparatus 200.

The distance between the level of the sample holder 1 that is mounted to the stage of the thermal setting element 3 and the level of the optical detector 4 is about 4.5 cm.

Not visible on the figures, a lens could be arranged between the sample holder 1 and the optical detector 4.

The optical detector 4 is configured to detect at least one optical signal from one sample volume of one indentation 11 of the sample holder 1.

The optical signal that can be detected by the optical detector 4 is preferably an optical signal that is generated by the liquid sample volume if the sample volume is excited by light that is reflected on the surface area, in particular on the flat bottom area 111, of one of the indentations 11.

Preferably, the optical detector 4 receives an optical signal from each sample volume of the indentations 11 of the array 10 simultaneously.

The optical detector 4 comprises preferably a CCD or CMOS sensor as an optical sensor element. In particular, the optical detector 4 can comprise a lens for focussing the optical signal to the optical sensor element.

The apparatus 200 can comprise a light source 5 for exciting the sample volume. The light source 5 might be an individual lamp. Preferably, the light source 5 is designed as a set of lamps arranged close to and/or around the optical detector 4. The light source 5 might be one or more LEDs or a mercury lamp.

FIG. 4 shows a perspective view of an embodiment of an apparatus 200 according to the invention. The sample holder 1 is mounted to the apparatus 200.

Preferably, the sample holder 1 is mounted to the thermal setting element 3 or in particular to a stage of the thermal setting element 3 of the apparatus 200. In a further embodiment, the sample holder 1 could also be mounted to a stage of the apparatus 200, wherein the thermal setting element 3 is in thermal connection to the sample holder 1 for heating or cooling the sample holder 1 and the sample volumes respectively.

The body 2 serves as a housing and also as a scaffold for all the components of the apparatus 200.

The body 2 has preferably a pyramidal outer shape as shown in the figure. This shape of the body 2 is advantageous, since it has a bigger surface for a given machine volume and therefore its functionality as a heat sink is very efficient.

In particular the sample holder 1, if mounted to the apparatus 200 as shown in this figure, is thermally coupled to the body 2, such that the body 2 might serve as a thermal heat sink for enabling fast change of temperature of the sample holder 2.

The optical detector 4 and any optional lenses are arranged within a peak section 21 of the preferably pyramidal body 2. In addition, also the light source 5 can be arranged within this peak 21.

To mount the sample holder 2 to the apparatus 200, the peak section 21 can be lifted as shown in the figure and the sample holder 1 can be arranged onto the thermal setting element 3 or a stage of the thermal setting element 3.

The body 2 of the apparatus 200 can further comprise a screen 61, e.g. to display temperature data of the thermal setting element 3 or of a temperature sensor.

Preferably, the apparatus 200 has the dimensions of 8 cm×8 cm×17 cm and is very lightweight. Preferably, the apparatus 200 weights about 1 kg or about 500 g, very preferably below 1 kg.

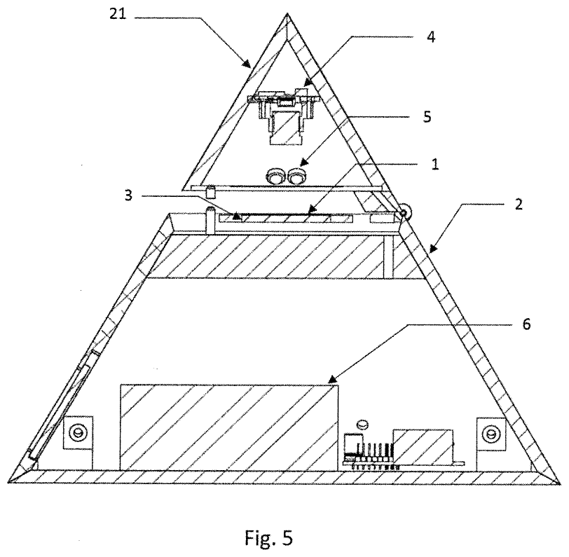

FIG. 5 shows a cross section of a preferred embodiment of the apparatus 200. The sample holder 1 is mounted to the apparatus 200.

The cross-sectional view reveals the interior of the apparatus 200. In particular, the optical detector 4 and the light source 5 are arranged in the peak section 21 of the apparatus body 2.

The sample holder 1 is mounted to the thermal setting element 3.

The light source 5 in this embodiment is arranged close by the location, in particular a stage, where the sample holder 1 is mounted.

The peak section 21 can be lifted for mounting the sample holder 1 onto the stage. In particular, the peak section 21 might be connected to the remaining body 2 by means of a hinge.

A controller 6 is arranged within the lower part, respectively the remaining part without the peak section 21, of the apparatus body 2.

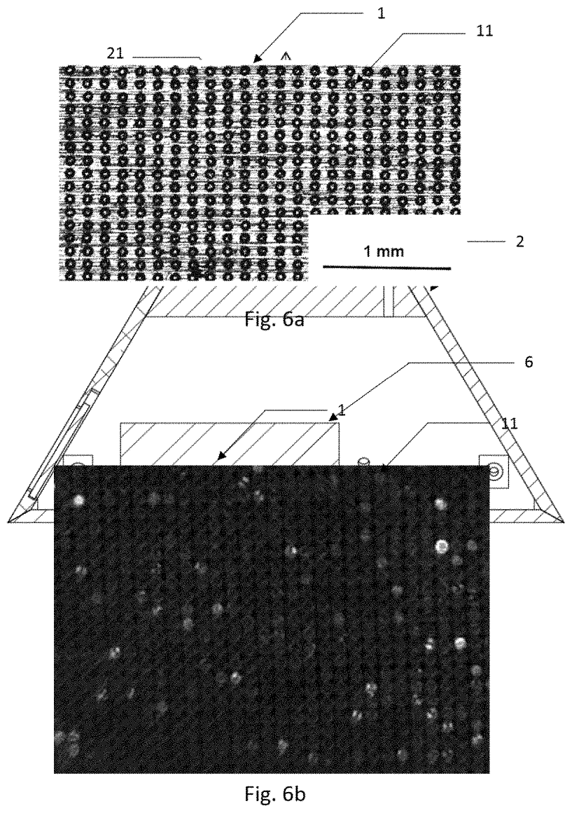

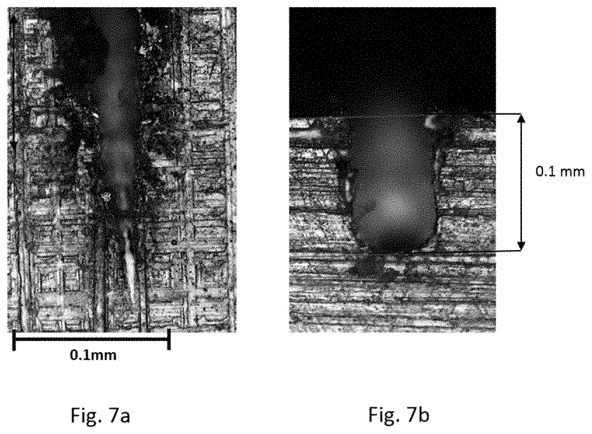

To further illustrate the invention, examples of measurements with the sample holder and the apparatus according to the invention are provided in the following and shown in FIGS. 6a and 6b and 7a and 7b. These examples are provided with no intend to limit the scope of the invention.

Example 1: A metallic sample holder according to claim 1 is manufactured by laser engraving of an array of indentations into a metal plate.

The laser engraving machine used in this example is able to generate a directional focused laser beam that is directed towards the indentations of the sample holder. In order to prevent overheating of the apparatus, the laser beam is pulsed at a given frequency. Therefore, the amount of exposure of the sample holder surface can be controlled by changing the duration of each pulse.

As soon as the beam reaches the surface of the sample holder, the energy of the beam is at least partly absorbed by the sample holder surface material and is therefore locally heating the sample holder. The local heating leads to evaporation of the material in the heated spot and therefore to the creation of an indentation.

By drawing the blueprint of the array of indentations in the software and setting the appropriate frequency and speed of the laser pulses, an array of indentations can be generated on the surface of the sample holder substrate. By repeating the procedure, multiple layers of material can be removed for adjusting the depth of the indentation.

In this example the sample holder is an aluminum plate with the dimensions of 40×40×0.3 mm. The aluminum plate is placed under a 20W fiber laser engraving machine. The blueprint of an array of indentations that extends over an area of approximately 10×10 mm is designed by means of the software. The controlling parameters of the engraving process are the scanning speed of the laser (set at 4000 mm/s), the power of the laser (set at 100%) and the pulse frequency (20 kHz).

The engraving process is repeated 12 times and therefore creating indentations with a depth of approximately 60 μm. Each indentation has a diameter of approximately 60 μm. The array of indentations manufactured by means of the presented method is shown in FIG. 6a.

Example 2: The detection capabilities of the device have been investigated by analyzing a sample volume comprising:
Mastermix: KAPA SYBR FAST qPCR Master Mix (2×), which contains KAPA SYBR FAST DNA Polymerase, reaction buffer, dNTPs, SYBR Green I dye, and MgCl2 at a final concentration of 2.5 mM

A forward primer:
(SEQ ID NO: 1)
AGA CGT GTG CTC TTC CGA TC
A reverse primer:
(SEQ ID NO: 2)
ACA CGA CGC TCT TCC GAT CT
Synthetic DNA:
Sequence (5′-3′):
(SEQ ID NO: 3)
ACA CGA CGC TCT TCC GAT CTG ACT CTC ATC TAC TAG
ATA GAT CTC CAC CTC GCA GTC TCG TCT TCA ACG GTG
CTC ACG CGA TAT AGT TAG CTC GCG ACT ACC ATA GCG
CTA CAT AGA AGT CAG CAA GAG ATC GGA AGA GCA CAC
GTC T
Sequence (5′-3′):
(SEQ ID NO: 4)
AGA CGT GTG CTC TTC CGA TCT CTT GCT GAC TTC TAT
GTA GCG CTA TGG TAG TCG CGA GCT AAC TAT ATC GCG
TGA GCA CCG TTG AAG ACG AGA CTG CGA GGT GGA GAT
CTA TCT AGT AGA TGA GAG TCA GAT CGG AAG AGC GTC
GTG T

A solution of bovine serum albumin
Deionized water

A sample volume smaller than 1 μL has been applied onto the sample holder according to Example 1. The sample holder has been placed under the optical detector and the excitation light source of the device. The excitation light source is composed of 8 commercial LEDs with a power rating of 3W and a central wavelength of 460 nm. The light sources were directed to the sample holder for exciting the sample volumes captured in the indentations of the sample holder array.

Detection was performed with a single-board computer (Raspberry Pi model 3B) equipped with a CCD camera (Raspberry Pi Camera Module v2) that was placed vertically above the center of the sample holder. A 12 mm lens was mounted onto the CCD camera and a long pass filter was placed in front of the lens (cut on frequency approximately at 580 nm). The signal was detected by recording the image produced by the CCD camera and saving it to an image file. Portion of the signal detected by the optical sensor is shown in FIG. 6b.

In FIG. 6b, the array of indentations (white circles) can be identified against the background.

Furthermore, indentations that respond to the excitation with a strong signal (such as the indentation in row 4, column 2 from the top-left corner) can be distinguished over indentations that are not producing any signal (such as the first indentation in the top left corner).

In digital PCR the detection is done by comparing the signal of each indentation with a specific threshold for determining whether the well contains amplified DNA or not.

### Example 3: Manufacturing of the metallic sample holder is shown in this example.

Two samples were produced, a comparison example in FIG. 7a and a sample that is produced with the manufacturing method according to the invention in FIG. 7b. Both samples comprise a metallic sample holder, wherein an indentation is fabricated into each sample by means of laser engraving with two different procedures. Both samples are manufactured on a aluminum plate of 40×40×0.3 mm. The plate is placed for each sample under a 20W fibre laser engraving machine. The laser is operated at 100% power and the pulse frequency is set to 20 kHz.

The laser engraving machine used in these experiments is able to generate a directional focused laser beam that is shining onto the surface of the substrate. When the beam hits the surface, the energy is at least partly absorbed and thus heat is transferred to the material. Due to this generation of heat, a portion of the substrate is completely evaporated and thus an indentation is created.

In the comparison example, the laser has been focused on one spot and the engraving process has been repeated continuously (without pauses) until the desired depth (around 100 um) was achieved. Due to the continuous operation of the laser, the material was not removed effectively and, as shown in FIG. 7a, the resulting well is very narrow and with a very limited bottom area. In the sample in FIG. 7b that has been manufactured with the method according to the present invention, the engraving process has been repeated 20 times at intervals of 3 seconds between every iteration. By doing so, a better evaporation and removal of material from the surface was achieved. As shown in FIG. 7b, the well obtained has a more defined lateral surface and a broader bottom area, mostly flat, compared to the comparison example as shown in FIG. 7a. Therefore, the fabrication of the indentations with the inventive method results in indentations that are favorable for performing measurements.

While there are shown and described presently preferred embodiments and examples of the invention, it is to be distinctly understood that the invention is not limited thereto but may be otherwise variously embodied and practised within the scope of the following claims.

1. A metallic sample holder (1), in particular for capturing sample volumes for digital polymerase chain detection reactions, comprising
an array of indentations (10),
wherein each indentation (11) is adapted to capture a maximal sample volume vₘₐₓ, with vₘₐₓ=2 nl, in particular with vₘₐₓ=1 nl, in particular with vₘₐₓ=0.8 nl,
wherein each indentation (11) of the array (10) has an area cross-section a, with a≤8*10⁻³ mm², in particular with a 5*10⁻³ mm²,
wherein the indentations (11) have a bottom area.

2. The metallic sample holder (1) of claim 1, comprising an array (10) with at least 10,000 indentations (11), in particular at least 40,0000 indentations (11).

3. The metallic sample holder (1) according to claim 1, consisting of aluminum, silver, gold, copper, or alloys thereof.

4. The metallic sample holder (1) according claim 1, wherein each indentation (11) is of cylindrical shape, of conical shape, or of elliptical cone shape and/or has at least partially a flat bottom area (111).

5. The metallic sample holder (1) according claim 1, wherein the surface of the indentations (11) is free of any coating.

6. The metallic sample holder (1) according to claim 1, further comprising a transparent, non-metallic covering sheet for covering the array of indentations (10).

7. The metallic sample holder (1) according to claim 1, wherein the bottom area is configured to reflect an optical signal.

8. A method for manufacturing of a metallic sample holder according to claim 1,
wherein the array of indentations is fabricated by means of laser engraving.

9. The method according to claim 8 wherein the laser engraving is performed by pulsing the laser repeatedly with pauses of at least 1 second, in particular with pauses of at least 2 seconds, very particular with pauses of at least 3 seconds.

10. The method according to claim 8 for comprising at least one step of chemical wet etching.

11. An apparatus (200), in particular for polymerase chain reaction detection, comprising the metallic sample holder (1) according to claim 1, comprising
a thermal setting element (3) thermally coupleable to the sample holder (1) for controlling the temperature of the sample holder (1),
a controller (6) for controlling a thermal cycle of the thermal setting element (3)
an optical detector (4) arranged in line of sight of the array of indentations (10) of the sample holder (1), wherein the optical detector (4) is configured to detect at least one optical signal from one sample volume of one indentation (11) of the sample holder (1).

12. The apparatus (200) according to claim 11 comprising an excitation light source (5).

13. The apparatus (200) according to claim 11, wherein the controller (6) is configured to control the optical detector (4) for recording the at least one optical signal for each thermal cycle of the thermal setting element (3).

14. The apparatus (200) according to claim 11, wherein the controller (6) is configured to control the optical detector (4) for recording a plurality of optical signals from a plurality of sample volumes of a plurality of indentations (11) for each thermal cycle of the thermal setting element (3).

15. The apparatus (200) according to claim 11, wherein the optical detector (4) is configured to assign each optical signal to the corresponding sample volume.

16. The apparatus (200) according to claim 11,
wherein the thermal interface conductance between the thermal setting element (3) and the sample holder (1) is at least 1000 W/(m²K), in particular at least 4000 W/(m²K), in particular at least 8000 W/(m²K).

17. The apparatus (200) according to claim 11, comprising at least one temperature sensor for sensing the temperature of the sample holder (1),
wherein the temperature sensor is connected to the controller (6) and the thermal setting element (3) for providing a feedback loop for controlling the temperature of the sample holder (1).

18. The apparatus 200) according to claim 11,
wherein the controller is configured to steer the thermal setting element (3) to heat the sample holder (1) with a net effective heating ramp equal or higher than 5.0° C./s, in particular equal or higher than 8.0° C./s, in particular equal or higher than 10.0° C./s, and/or
wherein the controller is configured to steer the thermal setting element (3) to cool down the sample holder with a net effective cooling ramp equal or lower than −5.0° C./s, in particular equal or lower than −8.0° C./s, in particular equal or lower than −10.0° C./s.

19. The apparatus (200) according to claim 11, comprising a body (2), in particular a metallic body,
wherein the metallic sample holder (1) is thermally coupleable to the body (2).

20. The apparatus 200) of claim 11 with a body (2) consisting of at least 80 wt % metal, in particular of at least 90 wt % metal, wherein in particular the metal is aluminum.

21. The apparatus (200) of claim 11 being portable, in particular being less than 1 kg of weight.

22. Use of the sample holder (1) according to claim 1 for the polymerase chain reaction detection of sample volumes, in particular by means of the apparatus (200) according to any one of claims 11 to 21.

23. An indentation of the sample holder according to claim 1, manufactured by a method comprising the steps of laser engraving, wherein the laser engraving is performed by pulsing the laser repeatedly with pauses of at least 1 second, in particular with pauses of at least 2 seconds, very particular with pauses of at least 3 seconds.

24. A metallic sample holder comprising at least one indentation according to claim 23.
